(19) United States
(12) Patent Application Publication
(10) Pub. No.: US 2015/0330132 A1
(43) Pub. Date: Nov. 19, 2015

(54) Garage Door Hinge

(71) Applicant: David Fraijo, Adelanto, CA (US)

(72) Inventor: David Fraijo, Adelanto, CA (US)

(21) Appl. No.: 14/676,355

(22) Filed: Apr. 1, 2015

Related U.S. Application Data
(60) Provisional application No. 61/994,311, filed on May 16, 2014.

(51) Int. Cl. E05D 15/24

(52) U.S. Cl. CPC E05D 15/242

(57) ABSTRACT

A hinge for removably joining adjacent garage door panels is provided. The hinge includes a first hinge bracket, a second hinge bracket, and a removable hinge pin. The first hinge bracket is mounted to a first panel and has a pair of first hinge pin holes therein for positioning adjacent to the first panel. The second hinge bracket is mounted to a second panel and has a pair of second hinge pin holes therein for positioning the first hinge pin holes in between the second hinge pin holes. The second hinge pin holes are aligned with the first hinge pin holes. The removable hinge pin is received in the first hinge pin holes and the second hinge pin holes. The removable hinge pin removably attaches the first panel to the second panel.

### CROSS REFERENCE TO RELATED APPLICATION

This application claims the benefit of U.S. Provisional Application No. 61/994,311 filed on May 16, 2014. The above identified patent application is herein incorporated by reference in its entirety to provide continuity of disclosure.

### FIELD OF THE INVENTION

The invention generally relates to a garage door hinge. More particularly, the present invention relates to a roll up garage door hinge that removably connects the panels of the garage door.

### BACKGROUND OF THE INVENTION

Overhead or garage doors are utilized in all types of residential and commercial applications to close off various building openings. These types of roll up doors are also utilized in many large trucks. Ordinarily, the doors include horizontal panels which are hinged together and moved vertically with respect to the opening. The panels include rollers at their ends, which move in tracks, to assist in the vertical movement. As the doors move vertically, the panels articulate with respect to one another ordinarily creating an opening in between two adjacent panels about the hinge.

Garage doors generally maintain two positions wherein the door must be fully opened or fully closed. Many people wish to allow fresh air within the garage and often resort to keeping the garage door fully open. This, however, can permit easy entry for thieves, animals and other intruders while allowing pets and children to easily exit the garage.

Therefore, a partially open garage door presents a serious security problem. Not only can children easily leave the garage area, thieves can easily enter the garage and steal valuable property such as tools and lawn equipment. Furthermore, small animals may wander into the garage. There is a need for keeping the garage door partially closed, yet capable of supplying air to cool the garage during the summer months. This should be accomplished without removing the standard garage doors and replacing the garage doors with a specialty door. Thus, there exists a need for a device that allows an individual to maintain a garage in a partially open position if desired that alleviates the above identified problems.

### SUMMARY OF THE INVENTION

In view of the foregoing disadvantages inherent in the known types of segmented garage doors now present in the prior art, the present invention provides a garage door hinge wherein the same can be utilized for providing convenience for the user when partially opening the garage door.

The present invention is contrived to solve the above problems, and a first object of the present invention is to provide a door hinge that removably attaches adjacent garage door panels to form a garage door.

It is another object of the present invention to provide a hinge for removably joining adjacent garage door panels. The hinge includes a first hinge bracket, a second hinge bracket and a removable hinge pin. The first hinge bracket is mounted to a first panel and has a pair of first hinge pin holes therein for positioning adjacent to the first panel. A second hinge bracket is mounted to a second panel and has a pair of second hinge pin holes therein for positioning the first hinge pin holes in between the second hinge pin holes.

It is yet another object of the present invention to have the second hinge pin holes in registration with the first hinge pin holes. The removable hinge pin is received in the first hinge pin holes and the second hinge pin holes and allows the first panel and the second panel to be pivotably connected.

Yet another aspect of the present invention is to provide a removable hinge pin that provides a pivot and removable attachment between the first panel and the second panel. The removable hinge pin pivotably attaches the first panel and the second panel for movement between the pivoted position and the aligned position. Additionally, the removable hinge pin removably attaches the first panel to the second panel for disconnecting the first panel from the second panel.

It is another object of the present invention to provide a removable hinge pin that can be removed from the first hinge bracket and the second hinge bracket to disconnect the first panel from the second panel.

It is yet another object of the present invention to provide the garage door hinge wherein the first hinge bracket and the second hinge bracket comprise at least two hinge pin holes on opposing sides of the bracket. The at least two hinge pin holes of the first hinge bracket are narrower than the at least two hinge pin holes of the second hinge bracket such the second hinge bracket can receive the at least two hinge pin holes of the first hinge bracket. The at least two hinge pin holes of the first hinge bracket and the at least two hinge pin holes of the second hinge bracket are in registration.

It is yet another object of the present invention to provide the garage door hinge with hinge brackets mounted at each juncture between adjacent door panels. The at least two hinge brackets are located at opposing sides of the adjacent doors.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a door hinge for removably joining adjacent garage door panels according to one embodiment of the present invention.

FIG. 2 shows a perspective view of a door hinge for removably joining adjacent garage door panels according to one embodiment of the present invention.

FIG. 3 shows a garage door with panels removably attached to the garage door via a hinge pin according to one embodiment of the present invention.

### DETAILED DESCRIPTION OF THE INVENTION

Reference is made herein to the attached drawings. Like reference numerals are used throughout the drawings to depict like or similar elements of the door hinge system. For the purposes of presenting a brief and clear description of the present invention, the preferred embodiment will be discussed as used for pivotally connecting the panels of a roll-up or overhead garage door. The figures are intended for representative purposes only and should not be considered to be limiting in any respect.

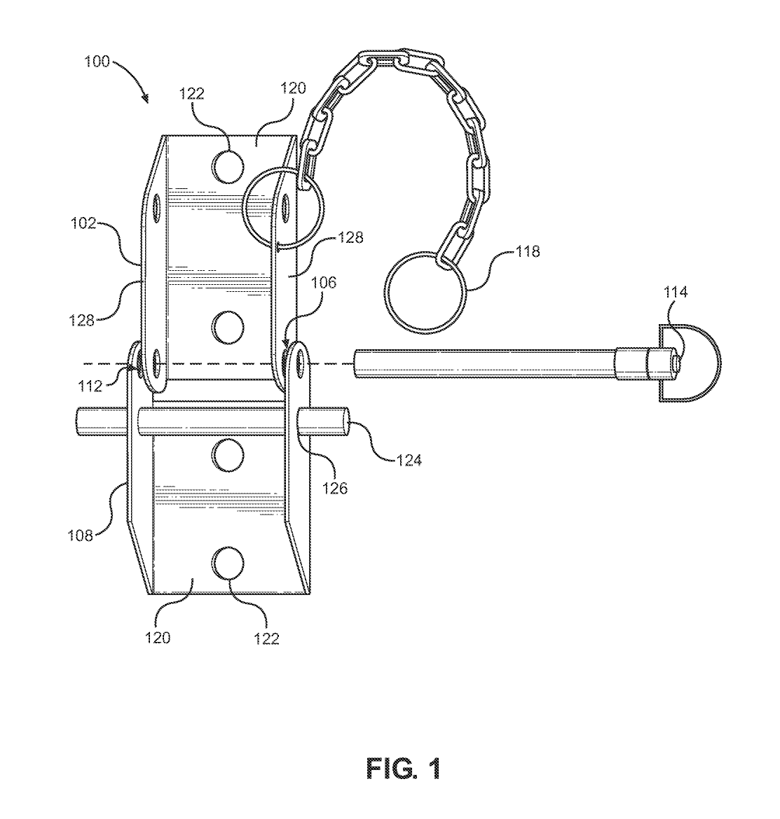

Referring now to FIG. 1, there is shown a door hinge for removably joining adjacent garage door panels according to one embodiment of the present invention. The hinge 100 includes a first hinge bracket 102 adapted to be mounted to a first panel. The first hinge bracket 102 has a pair of first hinge pin holes 106 therein for positioning adjacent to the first panel. A pair of first hinge brackets 102 are provided for each adjacent door panel, the pair of first hinge brackets are located on opposing ends of the a door panel. In one embodiment, the first panel may be an upper panel of the garage door.

A second hinge bracket 108 is adapted to be mounted to a second panel. The second hinge bracket 108 has a pair of second hinge pin holes 112 therein for positioning adjacent to the first panel. The second hinge pin holes 112 are in registration with the first hinge pin holes 106. The first hinge bracket 102 and the second hinge bracket 108 may include additional pin holes on opposing sides of the bracket. In the illustrated embodiment, each bracket 102, 108 comprises two pin holes on opposing sides thereof. The first hinge bracket 102 is narrower than the second hinge bracket 108. The at least two hinge pin holes of the second hinge bracket 108 can receive the at least two hinge pin holes of the first hinge bracket 102. The at least two hinge pin holes of the first hinge bracket 102 and the at least two hinge pin holes of the second hinge bracket 108 are in registration such that they can receive a removable hinge pin 114. In an alternate embodiment, the second hinge bracket 108 may include an end hinge member 124. The end hinge member 124 is a pin that extends through apertures 126 in the second hinge bracket 108. The end hinge member 124 is affixed to existing mounting holes on the garage door panels.

A removable hinge pin 114 is received in the first hinge pin hole 106 and the second hinge pin hole 112. The removable hinge pin 114 pivotably attaches the first hinge bracket 102 and the second hinge bracket 108 for movement between a pivoted position and an aligned position. The removable hinge pin 114 pivotably attaches the first panel and the second panel for movement between the pivoted position and the aligned position. The removable hinge pin 114 removably attaches the first panel to the second panel. In one embodiment, each bracket comprises a base plate 120 that rests flush against a garage door panel, and includes outwardly extending flanges 128 on opposing sides thereof, wherein each flange 128 includes a pin hole. The pin holes on the bracket are aligned and are separated by a space. The base plate 120 further includes apertures 122 that receive a bolt to be fasten the brackets to a garage door panel.

The removable hinge pin 114 is removed from the first hinge bracket 102 and the second hinge bracket 108 to disconnect the first panel from the second panel. In a preferred embodiment, the garage door may include a first hinge bracket 102 and a second hinge bracket 108 at each juncture between adjacent door panels. The removable hinge pin 114 located at each juncture between adjacent door panels can be removed to disconnect additional door panels from the garage door.

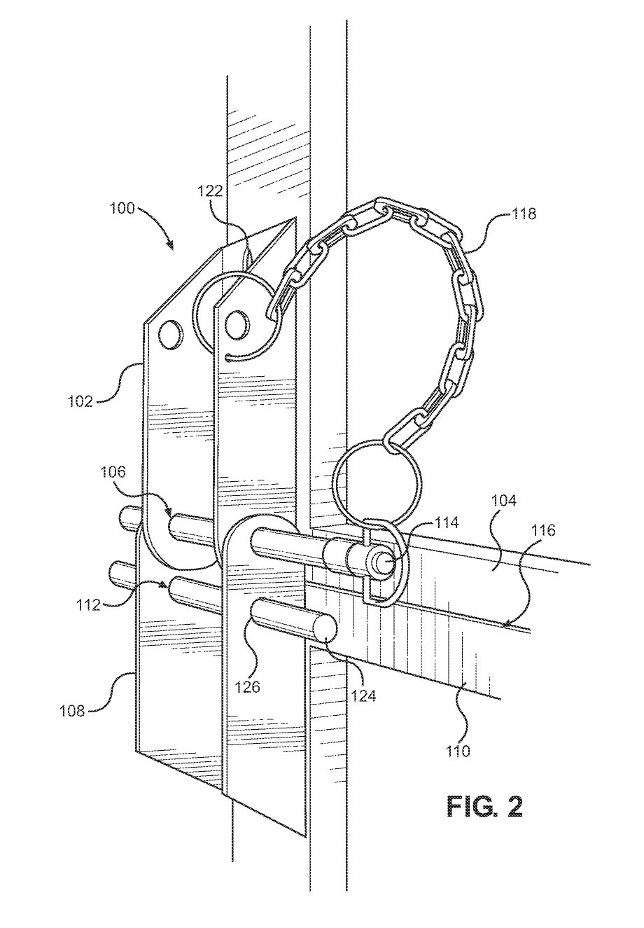

Referring now to FIG. 2, there is shown a door hinge for removably joining adjacent garage door panels. The hinge 100 includes a first hinge bracket 102 and a second hinge bracket 108 mounted at a juncture 116 between adjacent door panels. The first hinge bracket 102 is mounted on a first panel 104 via bolts that are driven through apertures 122 in the base plate 120 of the bracket. Similarly, the second hinge bracket 108 is mounted on a second panel 110 via bolts that are driven through apertures 122 in the base plate 120 of the bracket. The first hinge bracket 102 has a pair of first hinge pin holes 106 and the second hinge bracket 108 has a pair of second hinge pin holes 112. The second hinge bracket 108 may include an end hinge member 124 therethrough. The end hinge member 124 is a pin that extends through apertures 126 in the second hinge bracket 108. The end hinge member 124 is affixed to existing mounting holes on the garage door panels.

A removable hinge pin 114 is received in the first hinge pin holes 106 and the second hinge pin holes 112. The removable hinge pin 114 pivotably attaches the first hinge bracket 102 and the second hinge bracket 108 for movement between a pivoted position and an aligned position. The removable hinge pin 114 may further include a chain link 118 adapted to remove the removable hinge pin 114 from the first hinge pin hole 106 and the second hinge pin hole 114.

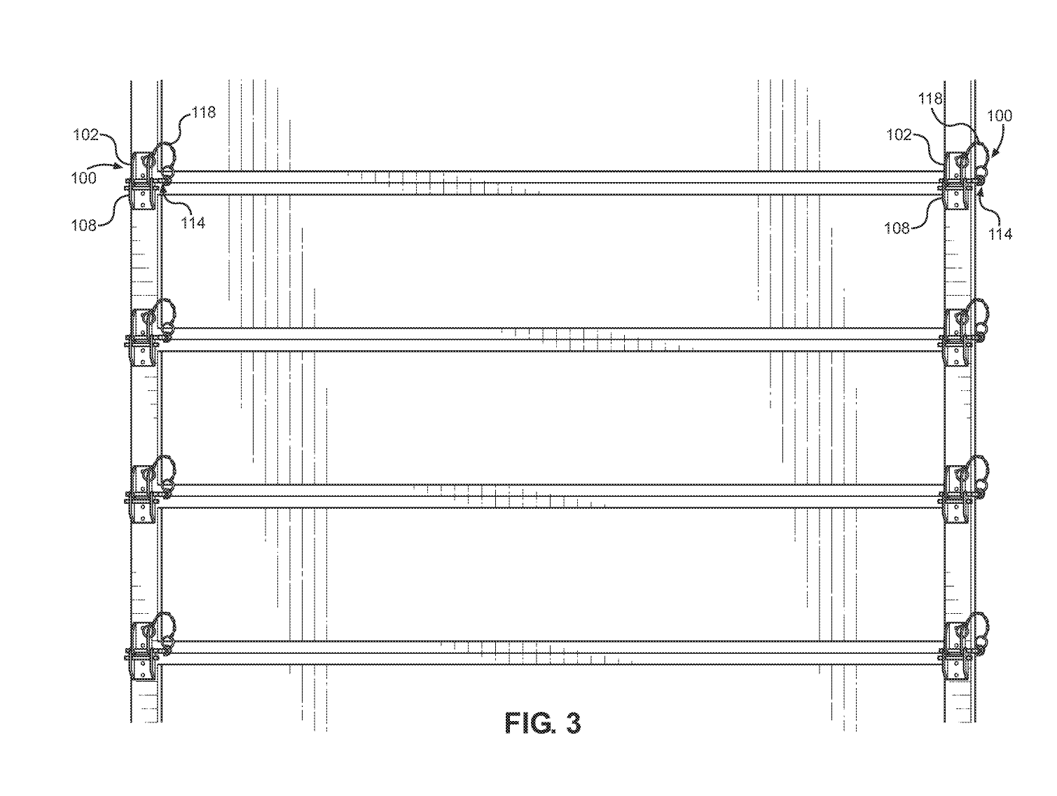

Referring now to FIG. 3, there is shown a garage door panel with panels removably attached to the garage door via a removable hinge pin 114 according to one embodiment of the present invention. The hinge 100 includes a pair of first hinge brackets 102 and a pair of second hinge bracket 108 mounted at a juncture 116 between adjacent door panels. The hinge 100 can be utilized in conjunction with a roll up garage door in order to enable the garage door to be opened at varying levels of height by removing the panels via the locking pin 114. The hinge 100 system removably attaches individual door panels to adjacent door panels to form the garage door. The hinge 100 allows a garage door to have one-quarter, one-half, and three-quarter opening positions in order to allow a user to maintain a comfortable opening level while conducting various tasks and the like in a garage.

In one embodiment, existing hinges are removed from a garage door and then replaced with the hinge system of the present invention. The hinge 100 may be bolted to existing mounting holes on the garage door, thus allowing a user to adjust a garage door to varying heights. This allows a user to have fresh air flow into a garage, while keeping animals and other intruders from entering. Further, the device can prevent children, pets and the like from exiting the garage.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A door hinge for removably joining adjacent garage door panels, the hinge comprising:
a first hinge bracket adapted to be mounted to a first panel, the first hinge bracket having a pair of first hinge pin holes therein for positioning adjacent to the first panel;
a second hinge bracket adapted to be mounted to a second panel, the second hinge bracket having a pair of second hinge pin holes, wherein the second hinge pin holes are in registration with the first hinge pin holes;
a removable hinge pin received in the first hinge pin holes and the second hinge pin holes, the removable hinge pin pivotally coupling the first hinge bracket and the second hinge bracket for movement between a pivoted position and an aligned position;
wherein the removable hinge pin removably attaching the first panel to the second panel.

2. The garage door hinge of claim 1, wherein the removable hinge pin disconnects the first panel from the second panel.

3. The garage door hinge of claim 1, wherein the first hinge bracket and the second hinge bracket are mounted at each juncture between adjacent door panels.

4. The garage door hinge of claim 3, wherein a pair of first hinge brackets and a pair of second hinge brackets are located at opposing ends of the adjacent door panels.

5. The garage door hinge of claim 1, wherein the first panel is an upper panel.

6. The garage door hinge of claim 1, wherein the second hinge bracket comprises an end hinge member extending through apertures in flange members of the second hinge member.

7. The garage door hinge of claim 1, wherein the removable hinge pin further comprises a chain link adapted to remove the removable hinge pin from the first hinge pin holes and the second hinge pin holes.

8. The garage door hinge of claim 1, wherein the first hinge bracket and the second hinge bracket comprise at least two hinge pin holes on opposing sides of the bracket.

9. The garage door hinge of claim 8, wherein the at least two hinge pin holes of the first hinge bracket are narrower than the at least two hinge pin holes of the second hinge bracket such the second hinge bracket can receive the at least two hinge pin holes of the first hinge bracket.

10. The garage door hinge of claim 9, wherein the at least two hinge pin holes of the first hinge bracket and the at least two hinge pin holes of the second hinge bracket are in registration.

11. A door hinge for removably joining adjacent garage door panels, the hinge comprising:
a pair of first hinge brackets adapted to be mounted to a first panel, the first hinge brackets having a pair of first hinge pin holes therein for positioning adjacent to the first panel;
a pair of second hinge bracket adapted to be mounted to a second panel, the second hinge brackets having a pair of second hinge pin holes, wherein the second hinge pin holes are in registration with the first hinge pin holes;
a removable hinge pin received in the first hinge pin holes and the second hinge pin holes, the removable hinge pin pivotally coupling the first hinge bracket and the second hinge bracket for movement between a pivoted position and an aligned position;
wherein the first hinge brackets are narrower than the second hinge brackets such that the second hinge bracket can receive the first hinge pin holes in a space between the second hinge pin holes;
wherein the removable hinge pin removably attaching the first panel to the second panel.
